(19) United States
(12) Patent Application Publication
(10) Pub. No.: US 2009/0309743 A1
(43) Pub. Date: Dec. 17, 2009

(54) Retractor device for smoke alarm and similar safety devices

(76) Inventor: Bryan Jonathan Tollman, Toronto (CA)

Correspondence Address: Mark A. Litman & Associates, P.A., 3209 West 76th St., York Business Center, Suite 205, Edina, MN, 55435, US

(21) Appl. No.: 12/456,169

(22) Filed: Jun. 12, 2009

Related U.S. Application Data
(60) Provisional application No. 61/060,957, filed on Jun. 12, 2008.

(51) Int. Cl. G08B 17/10

(52) U.S. Cl. 340/628

(57) ABSTRACT

A smoke alarm system has a housing containing a system that provides at least an audio signal when smoke is detected (e.g., a standard smoke detector). There may also be a connection plate and a support system associated with the connection plate and attached to the housing. The support system enables relative movement between the connection plate and the housing. In this manner, the connection plate can be attached to a surface and the smoke detector easily moved relative to that surface. The support system may have a moveable elongate element that is attached at one end to the housing. The connection plate may be attached to a surface, and movement of the support system causes the housing to move relative to the surface.

### CROSS-REFERENCE TO RELATED APPLICATIONS

This application claims the priority benefit of the provisional application Ser. No. 61/060,957, filed Jun. 12, 2008 by the present inventor.

### BACKGROUND OF THE INVENTION

1. Field of the Invention

The present technology relates to the convenient, safe retrieval and replacement of a smoke detector type device for maintenance service without having to climb up, a ladder or stand on a chair, to reach the device.

2. Background of the Art

Conventional methods of Smoke Alarm retrieval/replacement involve climbing up (a ladder or a chair) to the Smoke Alarm and retrieving the Alarm, then climbing back up to replace the Alarm on the ceiling. Further, the goal is to have the Smoke Alarm Retriever™ Product work seamlessly with existing Smoke Alarm design and installation method facilitating both after-market retrofit mounting and OEM Smoke Alarm sales.

U.S. Pat. No. 7,233,254 describes a lowered smoke detector is disclosed It comprises a sensor and a mounting system. The mounting system includes a frame, a securing device, a reel, a flexible member, a mounting adaptor, an activator, and a cover. The frame is mounted to the wall with the securing device to the wall. The reel with the flexible member wound about it and the activator hanging down is attached to the frame. The sensor is mounted to flexible member via mounting adaptor and hooks. Finally, the cover fits over the frame to complete the assembly. The operator pulls the activator in a clockwise or counterclockwise direction to lower or raise the sensor between a raised position for operation and a lowered position for servicing.

U.S. Pat. No. 7,204,534 describes a device for easy maintenance of smoke detectors, comprising a three dimensional “receptacle” that attaches to a pole and fits around a smoke detector housing to easily remove it from its mounting plate.

U.S. Pat. No. 6,672,636 describes a device for easy maintenance of smoke detectors, comprising a three dimensional “receptacle” that attaches to a pole and fits around a smoke detector housing to easily remove it from its mounting plate.

U.S. Pat. No. 6,644,617 An article to be mounted from or against the ceiling is removably coupled to a secured base fixedly secured to the ceiling, by a person standing on the floor of the room, supporting the article on the end of an elongated rod, and thrusting the article against the secured base with sufficient force to couple the article and the secured base. The article is removed from the secured base by inserting an end of the rod into the article, exerting a force on the rod to uncouple the article from the secured base, and supporting the article on the end of the rod as the article is lowered. The article is thus positioned on the ceiling, or hung from it, without being manually contacted by the person. The article may be a mounting member provided with fasteners such as hooks from which overhead signs may be hung and quickly interchanged without using a stepladder; of the article may be a smoke detector and alarm assembly which is directly mounted to the secured base.

U.S. Pat. No. 6,446,926 describes a smoke alarm retaining apparatus for making a smoke alarm easily reachable for servicing and testing. The smoke alarm retaining apparatus includes a base assembly that is adapted for coupling to a surface. An arm assembly is pivotally coupled to the base assembly such that the arm assembly is selectively positionable in a coplanar relationship with the base assembly. A smoke detector is coupled to the arm assembly such that the arm assembly is selectively positionable in an angular relationship to the base assembly for facilitating positioning of the smoke detector whereby the arm assembly is adapted for facilitating access to the smoke detector.

### SUMMARY OF THE INVENTION

The Smoke Alarm Retriever Product which when (easily) mounted to virtually any standard Smoke Alarm or similar (ceiling attached) residential Safety Alarm product, allows the user to easily and safely (no climbing) lower and raise their Smoke Alarms and similar Alarm products to conduct regular maintenance including but not limited to changing the battery, testing the Alarm's function or replacing the Alarm unit. Further, the Smoke Alarm Retriever Product is designed to install and function seamlessly with Smoke Alarm Original Equipment Manufacturers (OEM) design specifications without alteration to the Smoke Alarm or the Smoke Alarm's ceiling attachment system or hardware as per the OEM design specifications or installation instructions allowing for after-market retrofit mounting to existing Smoke Alarms and or the OEM sale of the Smoke Alarm Retriever Product fitted to new Smoke Alarm devices.

### BRIEF DESCRIPTION OF THE FIGURES

Embodiments of the invention are illustrated by way of example, and not by way of limitation, in the figures of the accompanying images:

FIG. 1 shows the Smoke Alarm Retriever Product Suspension plate with a Smoke Alarm attached to a ceiling.

FIG. 2 shows the Smoke Alarm Retriever Product with Smoke Alarm mounted in raised or ceiling position.

FIG. 3 shows the Smoke Alarm Retriever Product with Smoke Alarm mounted in the lowered/maintenance position.

### DETAILED DESCRIPTION OF THE INVENTION

In the following description, for the purposes of explanation, specific details are set forth in order to provide a thorough understanding of the invention. However, it will be apparent that the invention may be practiced without these specific details.

A general description of the present technology may be as follows: A smoke alarm system having a housing containing a system that provides at least an audio signal when smoke is detected (e.g., a standard smoke detector). There may also be a connection plate and a support system associated with the connection plate and attached to the housing. The support system enables relative movement between the connection plate and the housing. In this manner, the connection plate can be attached to a surface and the smoke detector easily moved relative to that surface. The plate may be any structural material. The support system may have a moveable elongate element that is attached at one end to the housing. The connection plate may be attached to a surface, and movement of the support system causes the housing to move relative to the surface. The support system may be, by way of a non-limiting series of examples, a string, chain, cable, rope, or filament passing through the connection plate or through a guide attached to the connection plate. As a guide, there may be a set of pulley wheels, cable grips, toggles or the like. A simple set of holes in the plate can also work, with or without grooves or tubes to guide the support system along fixed lines of movement. The surface may be a horizontal surface, such as a ceiling. The smoke alarm system may have one end of the support system attached to the housing and another end of the support system connected to a vertical surface (e.g., wall, cabinet, post, hook, etc.). The housing may be stabilized against the ceiling by tension in the support system or by some gripping attachment, such as a snap attachment on the connection plate.

The Smoke Alarm Retriever Product can be made from a variety of components/materials (in a variety of colors) and Plate shapes including but not limited to metals, plastics, ball-chain, cord or fire resistant cord material and a variety of cord lock mechanisms.

In After-Market Retrofit Configuration the Smoke Alarm Retriever Product comprises of two plates:

A Suspension Plate which mounts to the ceiling by way of the Smoke Alarm's OEM fasteners (most commonly screws) and OEM screw position per the Smoke Alarm manufacturer's installation instructions. The Suspension Plate houses a Cord Lock mechanism with Ball-Chain Cord. One side of the Ball-Chain Cord is attached (holding the Smoke Alarm horizontally in relation to the ceiling) to the second Plate (called the Docking Plate) and threads up through and along the Suspension Plate to and through the Cord Lock mechanism to the User end of the Ball-Chain Cord allowing the user to reach the Ball-Chain Cord and move the Ball-Chain Cord laterally in the Release direction, releasing the Ball-Chain Cord from the Cord Lock mechanism, which (in the case of a standard ceiling height) results in lowering the Smoke Alarm to the level of an average adult person's waist by way of gravitational pull. The user can then move the Ball-Chain Cord laterally in the Locking direction to lock the cord in place allowing the Smoke Alarm to hang in mid air at the height of an average adult's waist, which allows the user to carry out the desired maintenance. When done with the maintenance activity, the user pulls the Ball-Chain Cord laterally in the Release direction, thereby releasing the Ball-Chain Cord from the Cord Lock mechanism, then pulling the Ball-Chain Cord downward, the user raises the Smoke Alarm returning it to the Suspension Plate and then by moving the Ball-Chain Cord laterally in the Lock direction, the Cord Lock mechanism grips the Ball-Chain Cord and holds the Docking Plate and Smoke Alarm in place on the ceiling where it functions as normal.

The second plate called the Docking Plate, hangs below the Suspension Plate, attached via the Ball-Chain Cord. The Smoke Alarm is mounted to the underside of the Docking Plate per OEM install instructions.

Cord Hook. Where the User end of the Ball-Chain Cord hangs down and due to its location in the home needs to be moved aside so as not to interfere with people walking underneath; the Smoke Alarm Retriever Product supplies a Cord Hook, a small metal hook with a nail-eye through which the supplied small nail can be nailed into an adjacent wall. The User end of the Ball-Chain Cord can then be held in place against a wall and out of people's way when not in use by this small hook.

2. In After-Market Retrofit Configuration the Smoke Alarm Retriever Product comprises of one plate: A Suspension Plate which mounts to the ceiling by way of the Smoke Alarm's OEM fastener (generally screws). The Suspension Plate houses a Cord Lock mechanism and Ball-Chain Cord. One side of the Ball-Chain Cord is attached (directly) to the Smoke Alarm device and the other end threads through Suspension Plate, to and through the Cord Lock mechanism to the User end of the Ball-Chain Cord. This allows the user to reach the Ball-Chain Cord, lower and raise their Smoke Alarm. Cord Hook. Where the User end of the Ball-Chain Cord hangs down and due to its location in the home needs to be moved aside so as not to interfere with people walking underneath; the Smoke Alarm Retriever Product supplies a Cord Hook, a small metal hook with a nail-eye through which the supplied small nail can be nailed into an adjacent wall. The User end of the Ball-Chain Cord can then be held in place against a wall and out of people's way when not in use by this small hook. The Smoke Alarm Retriever™ Product can be (easily) mounted to virtually any standard Smoke Alarm or similar (ceiling attached) residential Safety Alarm product, allows the user to easily and safely (no climbing) lower and raise their Smoke Alarms and similar Alarm products to conduct regular maintenance including but not limited to changing the battery, testing the Alarm's function or replacing the Alarm unit.

Further, the Smoke Alarm Retriever™ Product can be designed to be installed and function seamlessly with Smoke Alarm Original Equipment Manufacturers (OEM) design specifications without alteration to the Smoke Alarm or the Smoke Alarm's ceiling attachment system or hardware as per the OEM design specifications or installation instructions allowing for after-market retrofit mounting to existing Smoke Alarms and or the OEM sale of the Smoke Alarm Retriever Product fitted to new Smoke Alarm devices.

A review of the Figures will assist in a further understanding and enablement of the invention.

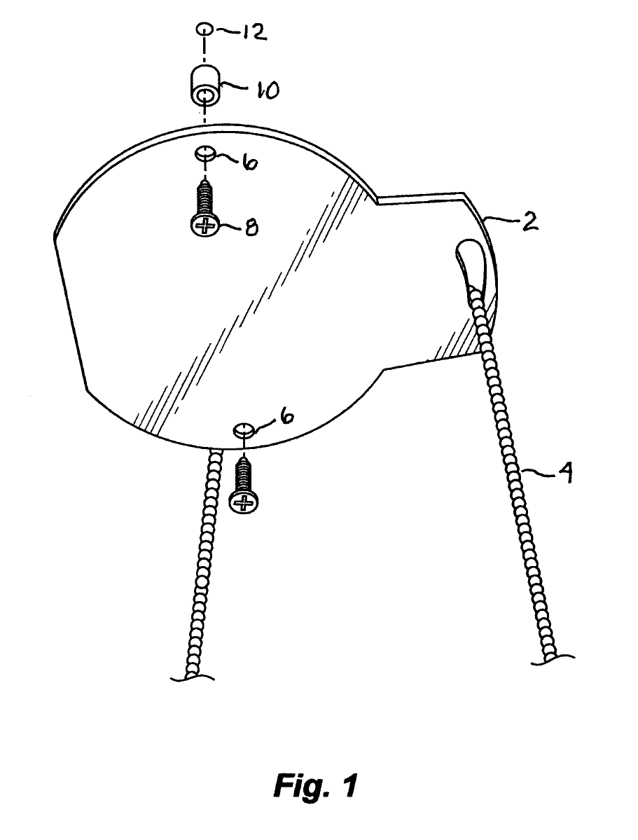

FIG. 1 shows the Smoke Alarm Retriever Product suspension plate 2 with a chain Smoke Alarm support system 4 attached through the suspension plate 2. The plate 2 is secured by screws 8 through holes 6 in the plate 2 through engaging elements 10 embedded in holes 12 in a surface (not shown, e.b., ceiling). The support system 4 is shown as a chain (e.g., metal beads attached to each other by wires).

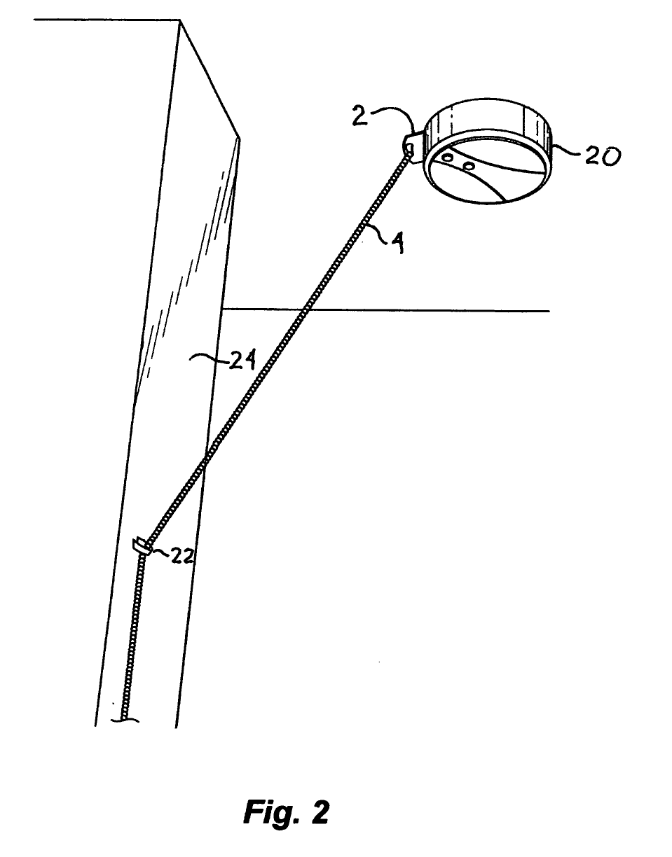

FIG. 2 shows the Smoke Alarm Retriever Product support plate 2 with a smoke alarm 20 mounted in raised or ceiling position. The support system 4 is shown attached to a wall 24 on which a clip 22 is provided to secure the support system 4, which maintains the elevation of the smoke alarm 20. The support system 4 and the plate 2 may be decorative at the design choice of the user and manufacturer.

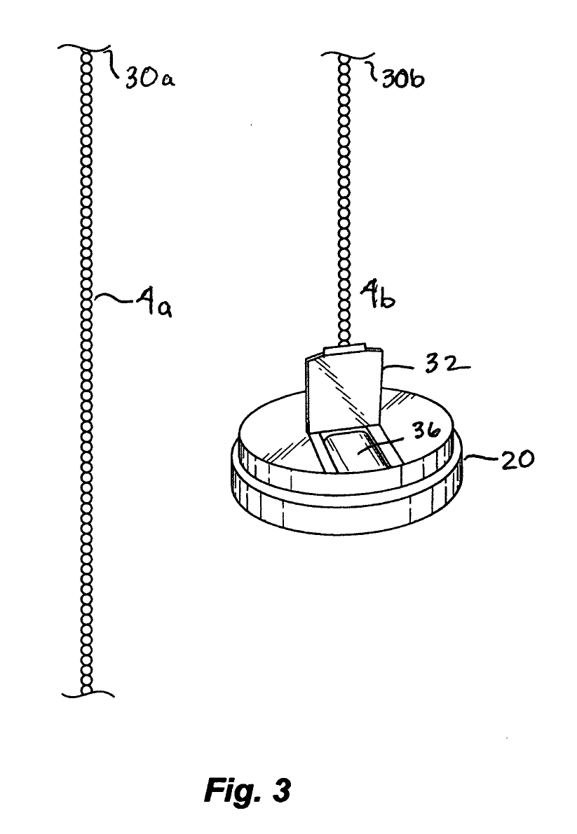

FIG. 3 shows the Smoke Alarm Retriever Product with smoke alarm 2 mounted in the lowered/maintenance position. One end 4a of the support system is used to pull the smoke alarm up towards an elevated surface (e.g., the plate 2 of previous Figures) with holes 30a and 30b allowing for movement of the ends 4a and 4b of the support system through the holes 30a and 30b. A panel 32 is shown opened on the smoke alarm 20 to expose the battery 36 therein to facilitate exchange of the battery or inspection of the smoke alarm 20.

A method of using the above described system to inspect or repair a smoke alarm supported on a ceiling would include steps of releasing tension on an elongated flexible element that is the sole support of the smoke alarm on the ceiling, lowering the smoke alarm to an elevation accessible by users relative to a floor without the use of ladders, opening a panel in the smoke alarm for inspection and/or replacement of batteries therein, then raising the smoke alarm by increasing tension on the elongated flexible element to raise the smoke alarm to the ceiling, and then securing the elongated flexible element to stabilize the smoke alarm against the ceiling. The plate is preferably secured to the ceiling and the elongated flexible element passes through the plate.

In the foregoing specification, the invention has been described with reference to specific embodiments thereof. However, various modifications and changes may be made thereto without departing from the broader spirit and scope of the invention. The specification and drawings are, accordingly, to be regarded in an illustrative sense rather than a restrictive sense.

What is claimed:

1. A smoke alarm system comprising:
a housing containing a system that provides at least an audio signal when smoke is detected;
a connection plate; and
a support system associated with the connection plate and attached to the housing,
the support system enabling relative movement between the connection plate and the housing.

2. The smoke alarm system of claim 1 wherein the support system comprises a moveable elongate element that is attached at one end to the housing.

3. The smoke alarm system of claim 2 wherein the connection plate is attached to a surface, and movement of the support system causes the housing to move relative to the surface.

4. The smoke alarm system of claim 3 wherein the support system comprises a string, chain, cable, rope, or filament passing through the connection plate or through a guide attached to the connection plate.

5. The smoke alarm system of claim 4 wherein the surface comprises a horizontal surface.

6. The smoke alarm system of claim 5 wherein the horizontal surface comprises a ceiling.

7. The smoke alarm system of claim 6 wherein one end of the support system is attached to the housing and another end of the support system is connected to a vertical surface.

8. The smoke alarm system of claim 7 wherein the housing is stabilized against the ceiling by tension in the support system.

9. The smoke alarm system of claim 7 wherein the housing is stabilized against the ceiling by a snap attachment on the connection plate.

10. A method of inspecting a smoke alarm supported on a ceiling comprising releasing tension on an elongated flexible element that is the sole support of the smoke alarm on the ceiling, lowering the smoke alarm to an elevation accessible by users relative to a floor without the use of ladders, opening a panel in the smoke alarm for inspection and/or replacement of batteries therein, then raising the smoke alarm by increasing tension on the elongated flexible element to raise the smoke alarm to the ceiling, then securing the elongated flexible element to stabilize the smoke alarm against the ceiling.

11. The method of claim 10 wherein a plate is secured to the ceiling and the elongated flexible element passes through the plate.
